(19) United States
(12) Patent Application Publication
(10) Pub. No.: US 2025/0193600 A1
(43) Pub. Date: Jun. 12, 2025

(54) VIBRATOR, ACOUSTIC SYSTEM, ACOUSTIC SYSTEM CONTROL METHOD, AND ACOUSTIC SYSTEM MANUFACTURING METHOD

(71) Applicants: Panasonic Automotive Systems Co., Ltd., Kanagawa (JP); Panasonic Connect Co., Ltd., Fukuoka (JP)

(72) Inventors: Tatsuya SHIMIZU, Hyogo (JP); Keisuke FUJIMOTO, Osaka (JP); Koji SANO, Kanagawa (JP); Yasunori MIYAMOTO, Kanagawa (JP)

(73) Assignees: Panasonic Automotive Systems Co., Ltd., Kanagawa (JP); Panasonic Connect Co., Ltd., Fukuoka (JP)

(21) Appl. No.: 18/965,702

(22) Filed: Dec. 2, 2024

(30) Foreign Application Priority Data
Dec. 11, 2023 (JP) 2023-208606

(51) Int. Cl. H04R 3/08; H04R 1/40; H04R 29/00

(52) U.S. Cl. CPC H04R 3/08; H04R 1/403; H04R 29/002

(57) ABSTRACT

A vibrator includes: a first vibration unit that generates an excitation force to be applied to a vibration member to which the first vibration unit is attached; a second vibration unit that generates an excitation force to be applied to the vibration member to which the second vibration unit is attached; and a regulation member to which the first vibration unit and the second vibration unit are secured and which regulates relative movements between the first vibration unit and the second vibration unit.

### CROSS REFERENCE TO RELATED APPLICATION

The present application is based on and claims priority of Japanese Patent Application No. 2023-208606 filed on Dec. 11, 2023.

### FIELD

The present disclosure relates to a vibrator that includes a plurality of vibration units, an acoustic system, an acoustic system control method, and an acoustic system manufacturing method.

### BACKGROUND

Patent Literature (PTL) 1 discloses a technique for effectively reducing noise resulting from a predetermined frequency by causing, to vibrate, a vibrator attached to a predetermined position on a vibration member.

### CITATION LIST

### Patent Literature

PTL 1: Japanese Unexamined Patent Application Publication No. H7-210174

### SUMMARY

However, the technique according to PTL 1 can be improved upon.

In view of this, the present disclosure provides a vibrator, an acoustic system, an acoustic system control method, and an acoustic system manufacturing method which are capable of improving upon the above related art.

A vibrator according to one aspect of the present disclosure includes: a first vibration unit that generates an excitation force to be applied to a vibration member to which the first vibration unit is attached; a second vibration unit that generates an excitation force to be applied to the vibration member to which the second vibration unit is attached; and a regulation member to which the first vibration unit and the second vibration unit are secured and which regulates relative movements between the first vibration unit and the second vibration unit.

An acoustic system according to one aspect of the present disclosure includes: (i) a vibrator that includes a first vibration unit that generates an excitation force to be applied to a vibration member to which the first vibration unit is attached, a second vibration unit that generates an excitation force to be applied to the vibration member to which the second vibration unit is attached, a regulation member to which the first vibration unit and the second vibration unit are secured and which regulates relative movements between the first vibration unit and the second vibration unit, a first correction filter that corrects an acoustic signal, and outputs the acoustic signal corrected to the first vibration unit, and a second correction filter that corrects the acoustic signal, and outputs the acoustic signal corrected to the second vibration unit; and (ii) a sound generation device that generates a sound wave based on the acoustic signal. The first correction filter and the second correction filter correct the acoustic signal to reduce transmitted sound that has changed from the sound wave by transmitting through the vibration member, and output the acoustic signals corrected to the first vibration unit and the second vibration unit.

An acoustic system control method according to one aspect of the present disclosure is an acoustic system control method of setting a filter property of a correction filter included in an acoustic system. The acoustic system includes: (i) a vibrator that includes a first vibration unit that generates an excitation force to be applied to a vibration member to which the first vibration unit is attached, a second vibration unit that generates an excitation force to be applied to the vibration member to which the second vibration unit is attached, a regulation member to which the first vibration unit and the second vibration unit are secured and which regulates relative movements between the first vibration unit and the second vibration unit, a first correction filter that corrects an acoustic signal, and outputs the acoustic signal corrected to the first vibration unit, and a second correction filter that corrects the acoustic signal, and outputs the acoustic signal corrected to the second vibration unit; and (ii) a sound generation device that generates a sound wave based on the acoustic signal. The first correction filter and the second correction filter correct the acoustic signal to reduce transmitted sound that has changed from the sound wave by transmitting through the vibration member, and output the acoustic signals corrected to the first vibration unit and the second vibration unit. The acoustic system control method includes: placing the sound generation device on one side of the vibration member to which the vibrator is attached; placing a measurement device on an other side of the vibration member; obtaining a target measurement signal by causing the measurement device to measure at least one of (i) a sound wave generated by the sound generation device based on the acoustic signal or (ii) vibration of the vibration member caused by the sound wave generated by the sound generation device; and setting the filter property of the correction filter based on a target sound-pressure transfer function between the acoustic signal and the target measurement signal.

An acoustic system manufacturing method according to one aspect of the present disclosure is an acoustic system manufacturing method of manufacturing an acoustic system. The acoustic system includes: (i) a vibrator that includes a first vibration unit that generates an excitation force to be applied to a vibration member to which the first vibration unit is attached, a second vibration unit that generates an excitation force to be applied to the vibration member to which the second vibration unit is attached, a regulation member to which the first vibration unit and the second vibration unit are secured and which regulates relative movements between the first vibration unit and the second vibration unit, a first correction filter that corrects an acoustic signal, and outputs the acoustic signal corrected to the first vibration unit, and a second correction filter that corrects the acoustic signal, and outputs the acoustic signal corrected to the second vibration unit; and (ii) a sound generation device that generates a sound wave based on the acoustic signal. The first correction filter and the second correction filter correct the acoustic signal to reduce transmitted sound that has changed from the sound wave by transmitting through the vibration member, and output the acoustic signals corrected to the first vibration unit and the second vibration unit. The acoustic system manufacturing method includes: placing the sound generation device on one side of the vibration member to which the vibrator is attached; placing a measurement device on an other side of the vibration member; obtaining a target measurement signal by causing the measurement device to measure at least one of (i) a sound wave generated by the sound generation device based on the acoustic signal or (ii) vibration of the vibration member caused by the sound wave generated by the sound generation device; and setting a filter property of a correction filter based on a target sound-pressure transfer function between the acoustic signal and the target measurement signal.

A vibrator, an acoustic system, an acoustic system control method, and an acoustic system manufacturing method according to one aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view of an external appearance of a vibrator from which a portion of each of suspensions is cut out.

FIG. 2 is a cross sectional view of an internal structure of the vibrator.

FIG. 3 is a diagram illustrating Example 1 of application of an acoustic system.

FIG. 4 is a diagram illustrating Example 2 of application of the acoustic system.

FIG. 5 is a diagram illustrating a state in which a sound generation device for measurement in a property generation system is actuated.

FIG. 6 is a diagram illustrating a state in which a first vibration unit of the sound generation device for measurement in the property generation system is actuated.

FIG. 7 is a diagram illustrating a state in which a second vibration unit of the sound generation device for measurement in the property generation system is actuated.

FIG. 8 is a diagram illustrating another example of the property generation system.

FIG. 9 is a perspective view showing another example, Example 1, of the vibrator.

FIG. 10 is a perspective view showing another example, Example 2, of the vibrator.

### DESCRIPTION OF EMBODIMENT

Hereinafter, an embodiment of a vibrator, an acoustic system, an acoustic system control method, and an acoustic system manufacturing method according to the present disclosure will be described with reference to the drawings. It should be noted that the embodiment below presents examples to describe the present disclosure, and thus is not intended to limit the present disclosure. For example, shapes, structures, materials, elements, relative positional relationships, connected states, numerical values, mathematical expressions, details of respective steps in methods, orders of the steps, etc., in the embodiment below are mere examples, and may include details not described below. Moreover, geometrical expressions such as parallel and orthogonal may be used, but these expressions do not denote mathematical strictness. These expressions include substantially allowable errors, deviations, etc. Expressions such as simultaneous and the same also include a substantially allowable range.

The drawings are schematic diagrams on which emphases, omissions, and/or proportional adjustments are performed as appropriate for describing the present disclosure. Accordingly, the drawings are different from the actual shapes, actual positional relationships, and/or actual proportions. In addition, the X axis, Y axis, and Z axis which may be shown in the drawings denote an orthogonal coordinate system optionally set for describing the drawings. In other words, the Z axis is not limited to an axis extended parallel to a vertical direction, and the X axis and the Y axis are not limited to axes present within a horizontal plane.

The following may comprehensively describe a plurality of inventions as one embodiment. Moreover, some contents presented below are described as optional elements relating to the present disclosure.

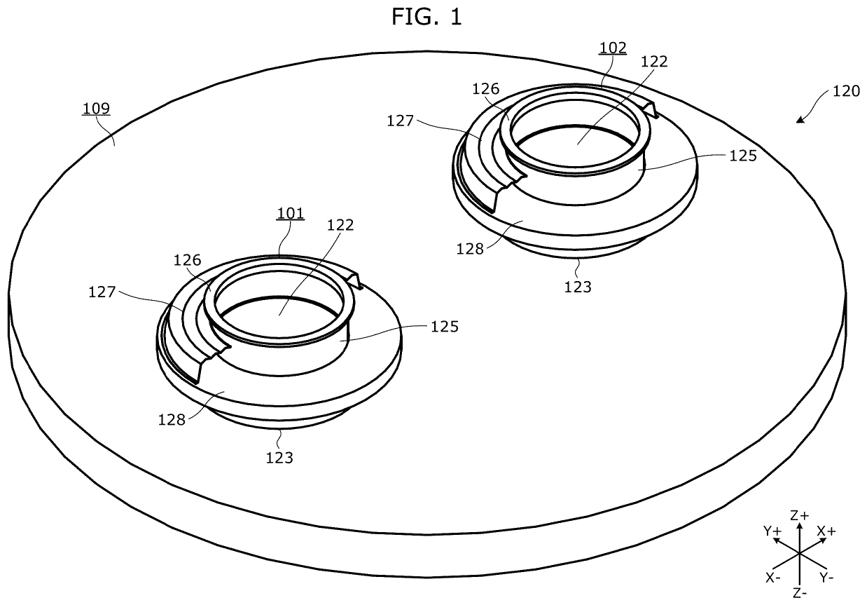

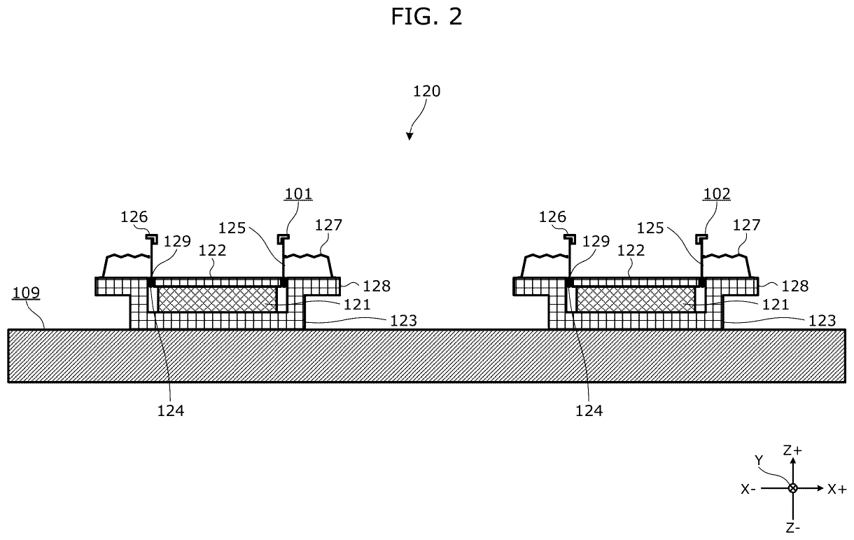

FIG. 1 is a perspective view of an external appearance of vibrator 120 from which a portion of each of suspensions 127 is cut out. FIG. 2 is a cross sectional view of an internal structure of vibrator 120. Vibrator 120 is attached to vibration member 220, and is the so-called actuator (excitor) that causes vibration member 220 to vibrate based on an inputted acoustic signal. Vibrator 120 includes a vibration unit that generates an excitation force and a reaction force generation mechanism that generates a reaction force opposing the excitation force. Vibrator 120 includes first vibration unit 101, second vibration unit 102, and regulation member 109.

First vibration unit 101 is a device that generates an excitation force to be applied to vibration member 220 (to be described later in the embodiment) to which first vibration unit 101 is attached. The type of a vibration unit included in vibrator 120 is not limited. For example, the vibration unit may use a piezoelectric element, a magnetostrictor, etc. As the reaction force generation mechanism, the following elements can be presented as examples: an element that uses an inertial force generated by mass effect of a movable part including a magnet, the regulation member, etc., and an element that uses a structural reaction force generated by joining one end of the movable part to another structural member. In the present embodiment, first vibration unit 101 is a magnet-type voice coil motor including magnet 121, top plate 122, bottom plate 123, voice coil 124, suspension 127, attachment member 126.

Magnet 121 is a magnetized, permanent magnet that is cylindrical in shape.

Top plate 122 is attached to one end face of magnet 121. In the present embodiment, top plate 122 is circular plate-shaped, has the diameter larger than the diameter of magnet 121, and has the central axis that aligns with the central axis of magnet 121.

Bottom plate 123 is attached to the other end face of magnet 121, and is a yoke that guides a magnetic flux from the other end face of magnet 121 to the vicinity of a circumferential surface of top plate 122. In the present embodiment, bottom plate 123 is cylindrical in shape and has a closed end. Flange portion 128 that is annular in shape extends outward from bottom plate 123. Bottom plate 123 coaxially accommodates magnet 121 and top plate 122, and magnetic gap 129 that is annular in shape is formed between top plate 122 and bottom plate 123.

Voice coil 124 is a coil that is disposed in magnetic gap 129 and to which acoustic signal 201 is input. An interaction between a varying magnetic force generated in voice coil 124 and a stationary magnetic force present in magnetic gap 129 causes an excitation force according to acoustic signal 201 to generate in a winding axis direction (the Z-axis direction in the diagrams) of a winding axis around which voice coil 124 is wound. In the present embodiment, voice coil 124 is wound around the circumference of bobbin 125 that is cylindrical in shape.

Suspension 127 is a member that elastically connects bobbin 125 and flange portion 128. Suspension 127 supports voice coil 124 and bobbin 125 such that voice coil and 124 and bobbin 125 linearly vibrate in the winding axis direction (the Z-axis direction in the diagrams) of voice coil 124.

Attachment member 126 is an annular-shaped member to be attached to vibration member 220. Attachment member 126 is attached to voice coil 124 with bobbin 125 interposed therebetween, and transmits vibration of voice coil 124 to vibration member 220.

With the above-described configuration, vibrator 120 causes, based on a force generated in voice coil 124, a magnetic circuit that includes magnet 121, top plate 122, and bottom plate 123 and a voice coil body that includes voice coil 124, bobbin 125, and attachment member 126 to relatively reciprocate in the winding axis direction of voice coil 124, to generate vibration. Vibrator 120 can apply vibration according to acoustic signal 201 to vibration member 220 bonded to attachment member 126 by adhering to attachment member 126. With this, sound waves according to acoustic signal 201 are generated from vibration member 220. First vibration unit 101 as described above includes an internal-magnetic-type magnetic circuit, but first vibration unit 101 may include an external-magnetic-type magnetic circuit.

Second vibration unit 102 is attached to vibration member 220 to which first vibration unit 101 is attached, and generates an excitation force to be applied to vibration member 220. In the present embodiment, second vibration unit 102 and first vibration unit 101 are of the same type, thus the description of second vibration unit 102 is omitted. Note that second vibration unit 102 and first vibration unit 101 need not be of the same type.

Regulation member 109 is a structural member to which first vibration unit 101 and second vibration unit 102 are secured and which regulates the relative movements between first vibration unit 101 and second vibration unit 102. Regulation member 109 has rigidity that can (i) maintain parallelism of the winding axes of voice coils 124 of first vibration unit 101 and second vibration unit 102 which are attached to vibration member 220 and (ii) regulate relative movements, such as skewed positioning of the two winding axes and a change in the distance between the two winding axes, even if different acoustic signals 201 are input to first vibration unit 101 and second vibration unit 102. Moreover, regulation member 109 has a given mass, and due to mass effect, generates an inertial force that serves as a reaction force to a driving force, together with, for example, magnets 121 and yokes 123 of vibration unit 101 and second vibration unit 102 which are joined to regulation member 109. The shape of regulation member 109 is not limited. Regulation member 109 need not be in the shape of a circular plate only as shown in FIG. 1. Regulation member 109 may adopt any optional shape, such as a quadrilateral and a triangle.

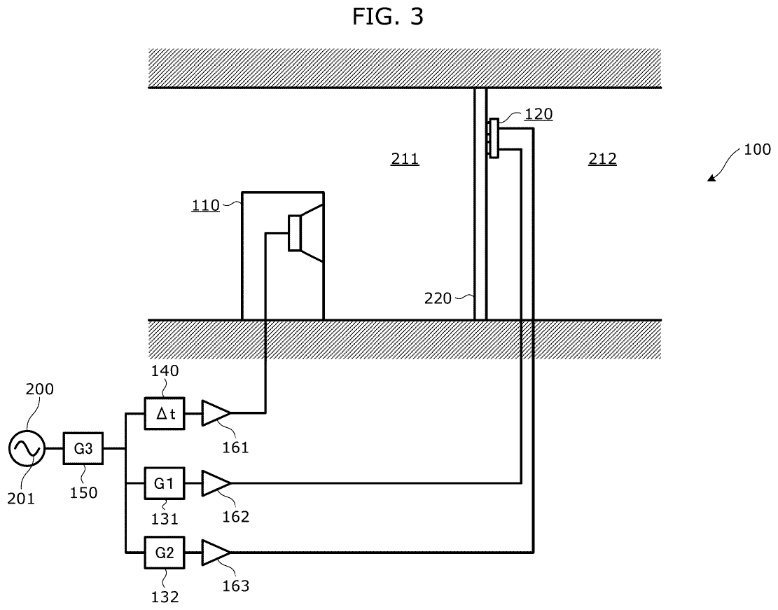

FIG. 3 is a diagram illustrating acoustic system 100. Acoustic system 100 is a system that generates sound waves in a given first space 211 and decreases the volume of transmitted sound that has transmitted into second space 212 through vibration member 220 by which second space 212 is separated from first space 211. In other words, acoustic system 100 is a system that reduces vibration of vibration member 220 caused by the sound waves generated in first space 211. Acoustic system 100 includes sound generation device 110, vibrator 120, first correction filter 131, and second correction filter 132. In the present embodiment, acoustic system 100 includes delay filter 140, common filter 150, first activation amplifier 161, second activation amplifier 162, and third activation amplifier 163.

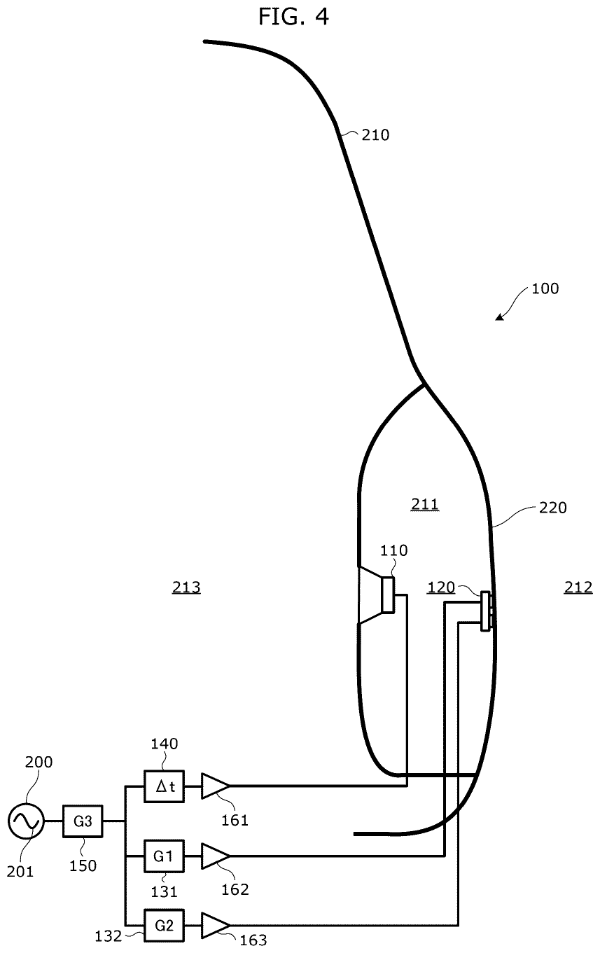

First space 211 is a space in which sound waves are emitted by sound generation device 110. First space 211 is not limited. For example, as illustrated in FIG. 4, first space 211 may be an internal space of mobile objects, such as vehicles, vessels, and aircraft, which functions as a cabinet (enclosure) that blocks diffraction of back sound emitted from the back of a loudspeaker unit of sound generation device 110 when sound generation device 110 emits sound in internal space 213 of a mobile object. First space 211 may also be an internal space of a cabinet (enclosure) of a typical loudspeaker system.

Second space 212 is a space separated from first space 211 by vibration member 220. Second space 212 is a space in which sound waves, which have been emitted inside first space 211 by sound generation device 110, are desired to be transmitted through the vibration member and propagated inside second space 212 as little as possible. Note that first space 211 may be isolated from second space 212 by vibration member 220 or first space 211 and second space 212 may be spatially connected although separated by vibration member 220. In addition, when first space 211 is, for example, an internal space of a cabinet (enclosure) of a loudspeaker system, second space 212 may be a space spatially connected with mobile object internal space 213 in which sound generation device 110 emits sound waves or may be a space equivalent to mobile object internal space 213 in which sound generation device 110 emits sound waves. Note that mobile object internal space 213 is not limited. For example, when first space 211 is an internal space of a cabinet (enclosure) of a typical loudspeaker system, mobile object internal space 213 may be a non-moving indoor space or a non-moving outdoor space in which sound waves are emitted from sound generation device 110.

Vibration member 220 is a member to which vibration is applied by vibrator 120. Vibration member 220 is not limited. For example, as illustrated in FIG. 4, vibration member 220 may be a part or the whole of a door or a part or the whole of the body of mobile objects, such as vehicles, vessels, and aircraft. Moreover, vibration member 220 may be a wall, a fence, or the like which is provided to separate first space 211 and second space 212. In addition, when first space 211 is, for example, an internal space of a cabinet (enclosure) of a loudspeaker system, vibration member 220 may be a structural member of the cabinet (enclosure).

Sound generation device 110 is a device that generates sound waves in first space 211, based on acoustic signal 201 output from signal source 200. The type of sound generation device 110 is not limited. As sound generation device 110, a loudspeaker unit, a vibrator for sound generation that causes a target to vibrate to cause the target to emit sound, and the like can be presented as examples. Moreover, sound generation device 110 may include, for example, a cabinet (enclosure) that accommodates a loudspeaker unit and vibration member 220 to which a vibrator for sound generation is to be attached. Sound generation device 110 may also include a plurality of loudspeaker units or a plurality of vibrators for sound generation, or may be a multi-way loudspeaker including various types of loudspeaker units.

Acoustic system 100 includes vibrator 120 that is the above-described vibrator 120, first vibration unit 101, second vibration unit 102, and regulation member 109. Acoustic signal 201 to be output to vibrator 120 and acoustic signal 201 to be output to sound generation device 110 are acoustic signals 201 output from the same source. Acoustic signal 201 output from the same signal source 200 is diverged to be output to each of three elements, sound generation device 110, first vibration unit 101 of vibrator 120 and second vibration unit 102 of vibrator 120. Note that the type of the vibration units is not limited; the vibration units each may use a piezoelectric element, a magnetostrictor, etc. As a reaction force generation mechanism, the following elements can be presented as examples: an element that uses an inertial force generated by mass effect of a movable part including a magnet, the regulation member, etc., and an element that uses a structural reaction force generated by joining one end of the movable part to another structural member.

First correction filter 131 corrects one of the diverged acoustic signals 201, and outputs the corrected acoustic signal 201 to first vibration unit 101 of vibrator 120. In the present embodiment, first correction filter 131 has a filter property unique to acoustic system 100. A filter property of first correction filter 131 is a property determined at least by sound generation device 110, vibrator 120, and vibration member 220 to which vibrator 120 is to be attached. A specific method of setting a filter property of first correction filter 131 will be described later in the embodiment.

Second correction filter 132 corrects a different one of the diverged acoustic signals 201, and outputs the corrected acoustic signal 201 to second vibration unit 102 of vibrator 120. In the present embodiment, second correction filter 132 has a filter property unique to acoustic system 100. A filter property of second correction filter 132 is a property determined at least by sound generation device 110, vibrator 120, and vibration member 220 to which vibrator 120 is to be attached. A specific method of setting a filter property of second correction filter 132 will be described later in the embodiment.

First correction filter 131 and second correction filter 132 correct two respective diverged acoustic signals 201 to be output to vibrator 120 so as to reduce transmitted sound that has changed from sound waves generated inside first space 211 by sound generation device 110 by transmitting through vibration member 220 and arrives at second space 212.

Delay filter 140 delays acoustic signal 201 to be output to sound generation device 110 by only Δt (fixed value) from acoustic signals 201 to be output to vibrator 120. Note that “t” represents time.

Common filter 150 is a filter that corrects acoustic signal 201 to be output to each of vibrator 120 and sound generation device 110. Common filter 150 is a filter that cuts a signal component that is an amount of sound waves generated by sound generation device 110 which first correction filter 131 and second correction filter 132 alone or first correction filter 131, second correction filter 132, and delay filter 140 alone cannot prevent from transmitting through vibration member 220. In the present embodiment, common filter 150 corrects acoustic signal 201 output from sound source 200, before being diverged. Note that common filter 150 may correct each of acoustic signals 201 after being diverged.

First activation amplifier 161 amplifies acoustic signal 201 output from signal source 200 until sound can be emitted in first space 211 by activating sound generation device 110. In the present embodiment, first activation amplifier 161 amplifies acoustic signal 201 that has been corrected by common filter 150 and then by delay filter 140.

Second activation amplifier 162 amplifies acoustic signal 201 output from signal source 200 to cause vibration member 220 to vibrate by activating first vibration unit 101. In the present embodiment, second activation amplifier 162 amplifies acoustic signal 201 that has been corrected by common filter 150 and then by first correction filter 131.

Third activation amplifier 163 amplifies acoustic signal 201 output from signal source 200 to cause vibration member 220 to vibrate by activating second vibration unit 102. In the present embodiment, third activation amplifier 163 amplifies acoustic signal 201 that has been corrected by common filter 150 and then by second correction filter 132.

Second activation amplifier 162 and third activation amplifier 163 amplify acoustic signals 201 to a degree that an amount of sound waves emitted in first space 211 by sound generation device 110 transmitting to second space 212 can be reduced.

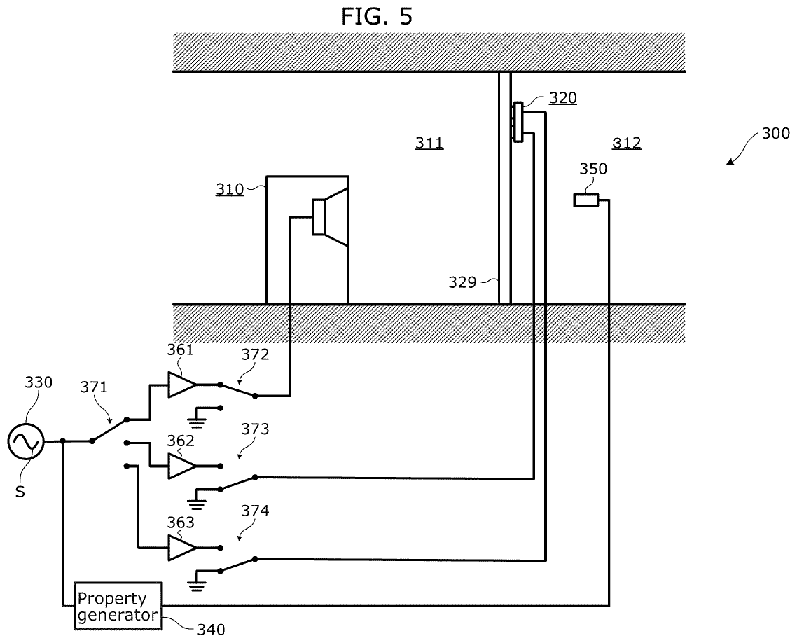

Next, property generation system 300 that can set a filter property of first correction filter 131 included in acoustic system 100 will be described. FIG. 5 is a diagram illustrating property generation system 300. Property generation system 300 is a system that generates a filter property of first correction filter 131 included in acoustic system 100. Property generation system 300 includes sound generation device 310 for measurement, vibrator 320 for measurement, vibration member 329 for measurement, sound source 330 for measurement, property generator 340, measurement device 350, first measurement amplifier 361, second measurement amplifier 362, third measurement amplifier 363, first changeover switch 371, second changeover switch 372, third changeover switch 373, and fourth changeover switch 374.

Sound generation device 310 for measurement is a device that generates, based on measurement acoustic signal S output from sound source 330 for measurement, sound waves in first measurement space 311. Sound generation device 310 for measurement is desirably the same as sound generation device 110 or is desirably the same type of device as sound generation device 110. Moreover, an aspect of attachment of sound generation device 310 for measurement to a cabinet or the like is desirably the same or substantially the same as the aspect of attachment of sound generation device 110. Furthermore, the position, orientation, and the like of sound generation device 310 for measurement relative to vibration member 329 for measurement are desirably the same or substantially the same as the position, orientation, and the like of sound generation device 110 relative to vibration member 220.

Vibrator 320 for measurement is a device that causes vibration member 329 for measurement to vibrate based on measurement acoustic signal S to be output from sound source 330 for measurement. Vibrator 320 for measurement is desirably the same as vibrator 120 or is desirably the same type of device as vibrator 120. Moreover, an aspect of attachment of vibrator 320 for measurement to vibration member 329 for measurement is desirably the same or substantially the same as the aspect of attachment of vibrator 120 to vibration member 220.

Sound source 330 for measurement outputs measurement acoustic signal S for measurement. Measurement acoustic signal S for measurement need not be acoustic signal 201 to be output to acoustic system 100. As measurement acoustic signal S for measurement, the following can be presented as examples: a given acoustic signal 201, a sine curve signal, a sweep sine signal, an impulse signal, a random noise signal, a colored noise signal, a maximum length sequence signal, and a time stretched pulse (TSP) signal.

Measurement device 350 is a device that measures (i) sound waves generated in second measurement space 312 by activating sound generation device 310 for measurement or vibrator 320 for measurement or (ii) vibration of vibration member 329 for measurement caused by activating sound generation device 310 for measurement or vibrator 320 for measurement. As measurement device 350 that measures sound waves, a microphone can be presented as an example. As measurement device 350 that measures vibration, a displacement sensor, a speed sensor, and an acceleration sensor can be presented as examples. Note that property generation system 300 may include a plurality of measurement devices 350.

Property generator 340 derives a filter property of first correction filter 131 included in acoustic system 100 based on a target sound-pressure transfer function between target measurement signal Ps and measurement acoustic signal S. Target measurement signal Ps is obtained by measuring, in second measurement space 312 which is not first measurement space 311 in which sound generation device 310 for measurement is placed among two spaces separated by vibration member 329 for measurement, (i) sound waves generated by sound generation device 310 for measurement based on measurement acoustic signal S or (ii) vibration of vibration member 329 for measurement which is caused by the sound waves. Property generator 340 derives a filter property of first correction filter 131 included in acoustic system 100 based on a target sound-pressure transfer function between target measurement signal Ps and measurement acoustic signal S. Target measurement signal Ps is obtained by measuring, in second measurement space 312, (i) sound waves generated by sound generation device 310 for measurement based on measurement acoustic signal S or (ii) vibration of vibration member 329 for measurement which is caused by the sound waves.

In addition to the above, in the present embodiment, property generator 340 derives a filter property of first correction filter 131 and a filter property of second correction filter 132 based on a corresponding sound-pressure transfer function between corresponding measurement signal Pv1 and measurement acoustic signal S and a corresponding sound-pressure transfer function between corresponding measurement signal Pv2 and measurement acoustic signal S, respectively. Corresponding measurement signals Pv1 and Pv2 are obtained by measuring, at the same position at which target measurement signal Ps has been measured, (i) sound waves generated as results of first vibration unit 101 and second vibration unit 102 of vibrator 320 for measurement separately causing vibration member 329 for measurement to vibrate based on acoustic signals S for measurement or (ii) the vibration of vibration member 329 for measurement. Property generator 340 derives the filter properties using the Fourier transform. A specific method of deriving will be described later in the embodiment. Property generator 340 is a processor implemented by causing a processor included in a dedicated or general-purpose computer to execute a property generation program.

First measurement amplifier 361 amplifies measurement acoustic signal S output from sound source 330 for measurement until sound can be emitted in first measurement space 311 by activating sound generation device 310 for measurement. First measurement amplifier 361 is desirably the same as first activation amplifier 161 or is desirably the same type of amplifier as first activation amplifier 161.

Second measurement amplifier 362 amplifies measurement acoustic signal S output from sound source 330 for measurement until vibration member 329 for measurement is caused to vibrate by activating first vibration unit 101 of vibrator 320 for measurement. Second measurement amplifier 362 is desirably the same as second activation amplifier 162 or is desirably the same type of amplifier as second activation amplifier 162.

Third measurement amplifier 363 amplifies measurement acoustic signal S output from sound source 330 for measurement until vibration member 329 for measurement is caused to vibrate by activating second vibration unit 102 of vibrator 320 for measurement. Third measurement amplifier 363 is desirably the same as third activation amplifier 163 or is desirably the same type of amplifier as third activation amplifier 163.

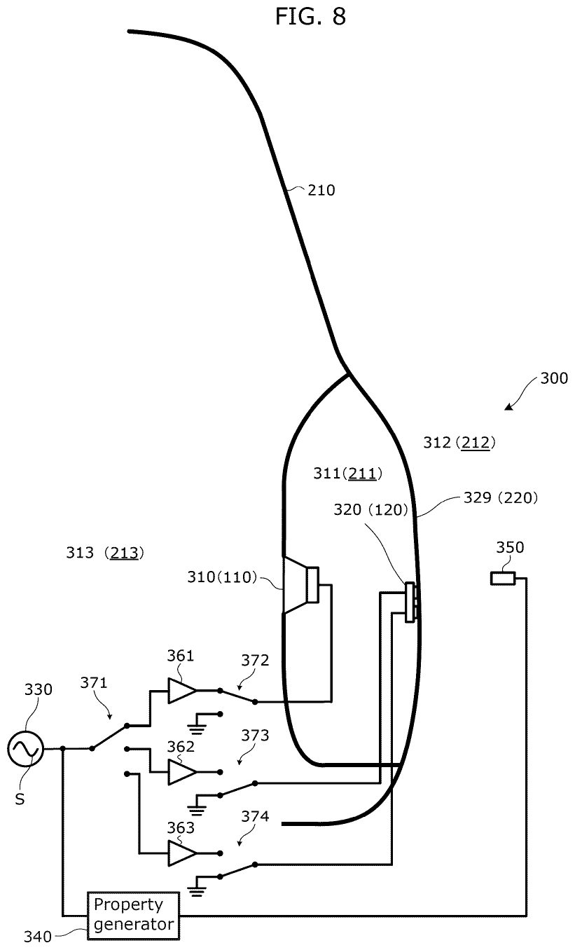

Note that, as illustrated in FIG. 8, property generation system 300 may use a part of acoustic system 100 attached to mobile object 210 to generate a filter property.

Next, an acoustic system manufacturing method of manufacturing acoustic system 100 using property generation system 300 will be described. As illustrated in FIG. 5, sound generation device 310 for measurement is placed at a given position inside first measurement space 311. Vibrator 320 for measurement is attached to vibration member 329 for measurement at a given position on vibration member 329 for measurement. Vibration member 329 for measurement is placed in first measurement space 311 that is on one side of vibration member 329 for measurement to which vibrator 320 for measurement is attached. Measurement device 350 is placed at a given position in second measurement space 312 that is on the other side of vibration member 329 for measurement. When sound waves inside second measurement space 312 are measured, measurement device 350 is placed at a position away from vibration member 329 for measurement. When vibration of vibration member 329 for measurement is measured, measurement device 350 is placed such that measurement device 350 is in contact with vibration member 329 for measurement. In this case, measurement device 350 may be placed inside first measurement space 311.

First changeover switch 371 and second changeover switch 372 are selected so as to cause sound generation device 310 for measurement to generate sound waves based on measurement acoustic signal S (see FIG. 5). In this case, at least one of (in the present embodiment, both) third changeover switch 373 and fourth changeover switch 374 is selected such that vibrator 320 for measurement is short-circuited.

Target measurement signal Ps is obtained by causing measurement device 350 to measure sound waves generated by sound generation device 310 for measurement or a vibration of vibration member 329 for measurement caused by the sound waves. At this stage, property generator 340 may derive filter property G of first correction filter 131 based on target sound-pressure transfer function Hs between measurement acoustic signal S and target measurement signal Ps.

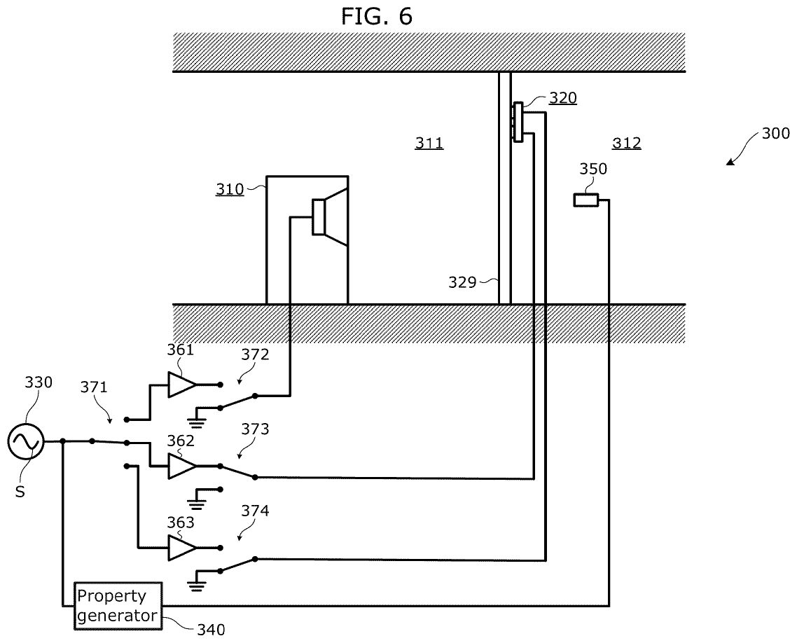

Next, in the present embodiment, first changeover switch 371 and third changeover switch 373 are selected so as to cause first vibration unit 101 of vibrator 320 for measurement to apply vibration to vibration member 329 for measurement based on measurement acoustic signal S (see FIG. 6). In this case, fourth changeover switch 374 is selected such that second vibration unit 102 is short-circuited. Note that second changeover switch 372 may be selected such that sound generation device 310 for measurement is short-circuited.

Without changing the position of measurement device 350 that has measured target measurement signal Ps, measurement device 350 is caused to measure (i) sound waves generated as a result of first vibration unit 101 causing vibration member 329 for measurement to vibrate based on measurement acoustic signal S or (ii) vibration of vibration member 329 for measurement, to measure corresponding measurement signal Pv1. Property generator 340 derives a corresponding sound-pressure transfer function Hv1 between measurement acoustic signal S and corresponding measurement signal Pv1, and derives filter property G1 of first correction filter 131 based on precedently-derived target sound-pressure transfer function Hs, using the following mathematical expressions.

$$Hs = Ps / S$$

$$Hv 1 = Pv 1 / S$$

$$Inverse function calculation : Hs \times S + Hv 1 \times G 1 \times S = 0$$

From the above, the mathematical expression G1=−Hs/Hv1 holds true.

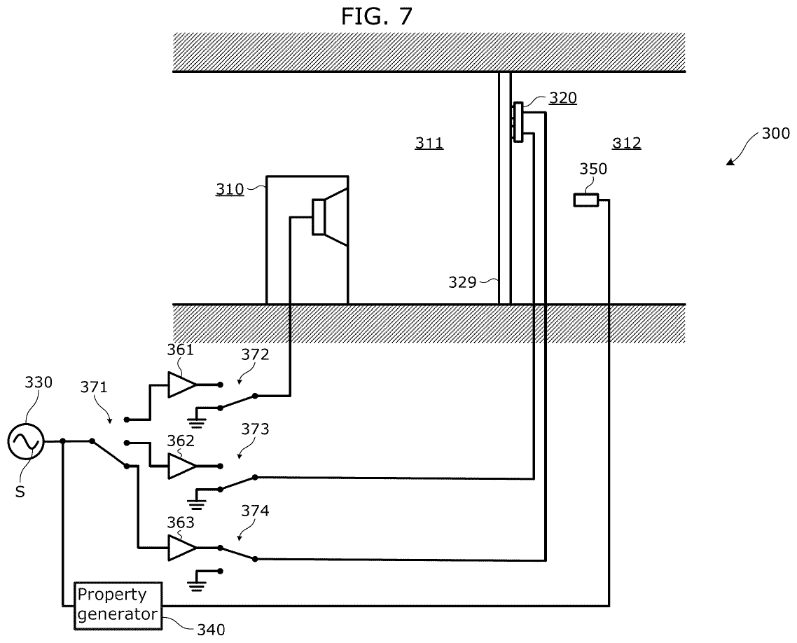

Next, first changeover switch 371 and fourth changeover switch 374 are selected so as to cause second vibration unit 102 of vibrator 320 for measurement to apply vibration to vibration member 329 for measurement, based on measurement acoustic signal S (see FIG. 7). In this case, third changeover switch 373 is selected such that short-circuit first vibration unit 101 is short-circuited. Note that second changeover switch 372 may be selected such that short-circuit sound generation device 310 for measurement is short-circuited.

Without changing the position of measurement device 350 that has measured target measurement signal Ps, measurement device 350 is caused to measure (i) sound waves generated as a result of second vibration unit 102 causing vibration member 329 for measurement to vibrate based on measurement acoustic signal S or (ii) vibration of vibration member 329 for measurement, to measure corresponding measurement signal Pv2. Property generator 340 derives a corresponding sound-pressure transfer function Hv2 between measurement acoustic signal S and corresponding measurement signal Pv2, and derives second filter property G2 of second correction filter 132 based on precedently-derived target sound-pressure transfer function Hs, using the following mathematical expressions.

$$Hs = Ps / S$$

$$Hv 2 = Pv 2 / S$$

$$Inverse function calculation : Hs \times S + Hv 2 \times G 2 \times S = 0$$

From the above, the mathematical expression G2=−Hs/Hv2 holds true.

Acoustic system 100 can be manufactured by respectively setting first filter property G1 of first correction filter 131 and second filter property G2 of second correction filter 132 which have been generated by property generator 340 to first correction filter 131 and second correction filter 132 which are included in acoustic system 100.

Short-circuiting of first vibration unit 101 and second vibration unit 102 included in vibrator 320 for measurement when target measurement signal Ps is measured produces the following advantageous effects. More specifically, sound waves generated by sound generation device 310 for measurement cause vibration member 329 for measurement to vibrate, and this vibration causes an induced current to be generated in internal wiring of vibrator 320 for measurement. Electrical energy of the generated induced current is consumed due to an internal resistance of each of first vibration unit 101 and second vibration unit 102. Due to this electrical energy consumption, first vibration unit 101 and second vibration unit 102 seemingly behave as if attenuation of their mechanical vibration systems have increased. In acoustic system 100, the above-described state is the same as the state in which vibrator 120 is reducing the vibration of vibration member 220 caused by sound waves generated by sound generation device 110. With this, the accuracy of first filter property G1 and second filter property G2 to be derived by property generation system 300 can be improved, and an amount of sound waves generated by sound generation device 110 transmitting through vibration member 220 can be effectively reduced.

Note that the present disclosure is not limited to the above-described embodiment. For example, the present disclosure may include different embodiments implemented by optionally combining elements described in the present specification or by excluding some of the elements described in the present specification. Moreover, the present disclosure also includes variations obtained by applying various modifications conceivable to those skilled in the art to each embodiment, without departing from the spirit of the present disclosure, or in other words, without departing from the meaning of wording recited in the claims.

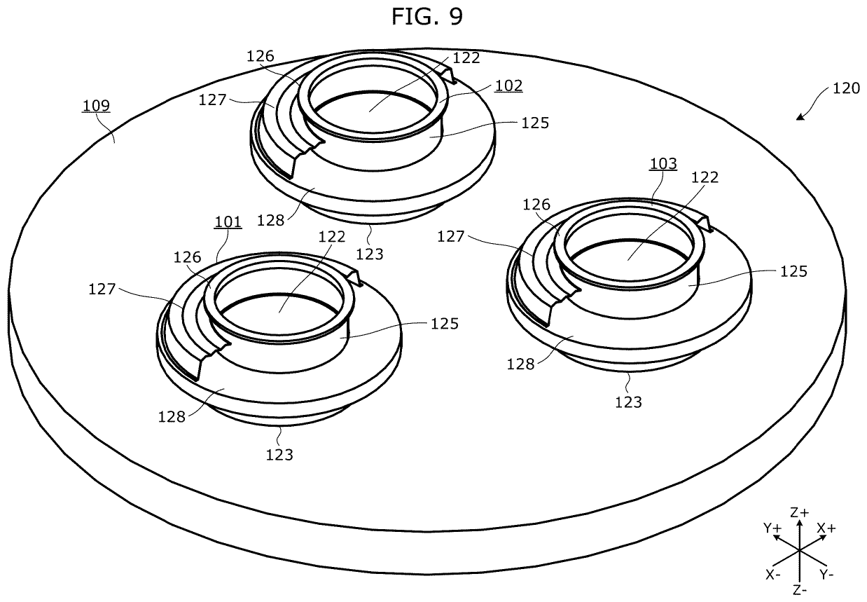

For example, vibrator 120 may include, as illustrated in FIG. 9, a single regulation member 109 that is provided with first vibration unit 101, second vibration unit 102, and third vibration unit 103. When vibrator 120 includes three vibration units, it is possible to produce a moment in any axis in a plane parallel to regulation member 109.

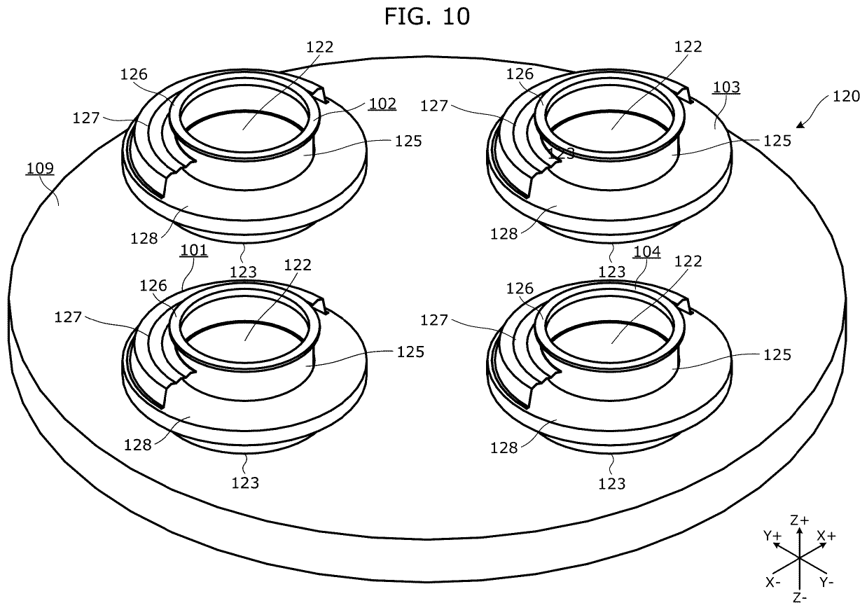

Moreover, vibrator 120 may include, as illustrated in FIG. 10, a single regulation member 109 that is provided with first vibration unit 101, second vibration unit 102, third vibration unit 103, and fourth vibration unit 104. Regulation member 109 may be provided with five or more vibration units. When vibrator 120 includes four or more vibration units, it is possible to readily produce a moment in any axis in a plane parallel to regulation member 109. These four or more vibration units may be arranged at positions equivalent to the positional relationship between a sun gear and planet gears in a planetary gear mechanism. For example, first vibration unit 101 may be arranged at the center of regulation member 109, and second vibration unit 102, third vibration unit 103, and fourth vibration unit 104 may be circumferentially arranged around the outer edge of first vibration unit 101. In this case, vibrator 120 can readily produce, on vibration member 220, a moment that can excite a vibration mode having a concentric nodal line around first vibration unit 101 as the center. Moreover, the four or more vibration units may be arranged at three-dimensional positions not on the same plane.

The manufacturing of acoustic system 100 by setting filter properties that have been derived based on property generation system 300 to first correction filter 131 and second correction filter 132 has been presented as an example. However, a filter property of first correction filter 131 and a filter property of second correction filter 132 may be derived through numerical analysis simulations, such as a finite element method (FEM) and lumped element modeling (LEM) (an equivalent circuit analysis method using lumped constant elements), to be set to first correction filter 131 and second correction filter 132 of acoustic system 100, respectively.

Moreover, the case where measurement device 350 provided at one position measures target measurement signal Ps and corresponding measurement signal Pv to derive first filter property G1 for first correction filter 131 and second filter property G2 for second correction filter 132 has been described. However, a plurality of measurement devices 350 may be provided at a plurality of positions or measurement device 350 may change positions to measure a plurality of target measurement signals Ps and a plurality of corresponding measurement signals Pv1 and Pv2 and may derive first filter property G1 and second filter property G2 based on the plurality of target measurement signals Ps and the plurality of corresponding measurement signals Pv1 and Pv2. In this case, a statistical process, such as a least-square method, may be performed on the plurality of target measurement signals Ps and the plurality of corresponding measurement signals Pv1 and Pv2 to calculate a single target measurement signal Ps and a single corresponding measurement signal Pv, and first filter property G1 and second filter property G2 may be derived using these calculated measurement signal Pv and corresponding measurement signal Pv.

The acoustic system has been described as an acoustic system that operates based on an acoustic signal reproduced in real time. However, (i) a signal obtained by causing the original acoustic signal to transmit through a correction filter or by convolving the correction filter with the original acoustic signal and (ii) a signal to which a fixed delay corresponding to the correction filter is added may be prepared in advance in a storage device, and these signals may be synchronized and reproduced. Then, the first signal may be supplied to the vibrator and the latter signal may be supplied to the sound generation device.

In property generation system 300, second changeover switch 372, third changeover switch 373, and fourth changeover switch 374 have been described as located on the output terminal sides of first measurement amplifier 361, second measurement amplifier 362, and third measurement amplifier 363. However, second changeover switch 372, third changeover switch 373, and fourth changeover switch 374 may be located on the input terminal sides. If a voltage-driven amplifier whose output impedance is sufficiently low is used as a measurement amplifier in this case, short-circuiting the input terminal of the measurement amplifier to the grounding potential produces the same advantageous effect as short-circuiting a changeover switch located on the output terminal side.

Vibrator 120 according to aspect 1 of the present disclosure includes: first vibration unit 101 that generates an excitation force to be applied to vibration member 220 to which first vibration unit 101 is attached; second vibration unit 102 that generates an excitation force to be applied to vibration member 220 to which second vibration unit 102 is attached; and regulation member 109 to which first vibration unit 101 and second vibration unit 102 are secured and which regulates relative movements between first vibration unit 101 and second vibration unit 102.

According to aspect 1, a moment can be applied to vibration member 220 as one of excitation forces. Accordingly, even if vibrator 120 is at a node of a wave, it is possible to cause vibration member 220 to generate the wave.

Vibrator 120 according to aspect 2 includes aspect 1. Vibrator 120 according to aspect 2 includes a first correction filter that corrects acoustic signal 201 and outputs the corrected acoustic signal 201 to first vibration unit 101 and a second correction filter that corrects acoustic signal 201 and outputs the corrected acoustic signal 201 to second vibration unit 102. According to aspect 2, it is possible to cause vibration member 220 to appropriately vibrate according to acoustic signal 201.

Acoustic system 100 according to aspect 3 includes vibrator 120 according to aspect 2 and sound generation device 110 that generates a sound wave based on the acoustic signal. First correction filter 131 and second correction filter 132 correct acoustic signal 201 to reduce transmitted sound that has changed from the sound wave by transmitting through vibration member 220, and output the corrected acoustic signals 201 to first vibration unit 101 and second vibration unit 102.

According to aspect 3, vibration of vibrator 120 can reduce an amount of sound waves generated by sound generation device 110 transmitting through vibration member 220.

Acoustic system 100 according to aspect 4 includes aspect 3. Acoustic system 100 according to aspect 4 includes a delay filter that delays acoustic signal 201, and outputs the delayed acoustic signal 201 to sound generation device 110.

According to aspect 4, it is possible to correct delay caused by, for example, a difference between a path through which acoustic signal 201 to be output to sound generation device 110 passes and a path through which acoustic signal 201 to be output to vibrator 120 passes, to effectively reduce an amount of sound that transmits through vibration member 220.

Acoustic system 100 according to aspect 5 includes aspect 3 or aspect 4. Acoustic system 100 according to aspect 5 includes a common filter that corrects both (i) acoustic signal 201 to be output to vibrator 120 and (ii) acoustic signal 201 to be output to sound generation device 110.

According to aspect 5, it is possible to cut signal components that cannot be reduced by vibration of vibration member 220 caused by vibrator 120, to reduce an amount of sound that transmits through vibration member 220.

Acoustic system 100 according to aspect 6 includes any one of aspects 3 to 5. In acoustic system 100 according to aspect 6, each of first correction filter 131 and second correction filter 132 has a filter property derived based on a target sound-pressure transfer function between a target measurement signal and acoustic signal 201. The target measurement signal is obtained by measuring, on a side of vibration member 220 at which sound generation device 110 is not placed, at least one of (i) a sound wave generated by sound generation device 110 based on acoustic signal 201 or (ii) vibration of vibration member 220 caused by the sound wave generated by sound generation device 110.

According to aspect 6, first correction filter 131 and second correction filter 132 which conform to actual conditions can be introduced to acoustic system 100. Accordingly, an amount of sound that transmits through vibration member 220 can be effectively reduced.

Acoustic system 100 according to aspect 7 includes aspect 6. In acoustic system 100 according to aspect 7, first correction filter 131 has a first filter property derived based on a first corresponding sound-pressure transfer function between a first corresponding measurement signal and acoustic signal 201. The first corresponding measurement signal is obtained by measuring, at a position at which the target measurement signal has been measured, at least one of (i) a sound wave generated as a result of vibrator 120 causing vibration member 220 to vibrate based on acoustic signal 201 or (ii) the vibration. Second correction filter 132 has a second filter property derived based on a second corresponding sound-pressure transfer function between a second corresponding measurement signal and acoustic signal 201. The second corresponding measurement signal is obtained by measuring, at the position at which the target measurement signal has been measured, at least one of (i) a sound wave generated as a result of vibrator 120 causing vibration member 220 to vibrate based on acoustic signal 201 or (ii) the vibration.

According to aspect 7, acoustic system 100 can include first correction filter 131 and second correction filter 132 having filter properties in which actual conditions are accurately reflected. Accordingly, transmission of sound waves generated by sound generation device 110 can be effectively reduced by vibrator 120 causing vibration member 220 to vibrate.

An acoustic system control method according to aspect 8 is an acoustic system control method of setting a filter property of a correction filter included in acoustic system 100 according to any one of aspects 3 to 7. The acoustic system control method according to aspect 8 includes: placing sound generation device 110 on one side of vibration member 220 to which vibrator 120 is attached; placing a measurement device on the other side of vibration member 220; obtaining a target measurement signal by causing the measurement device to measure at least one of (i) a sound wave generated by sound generation device 110 based on acoustic signal 201 or (ii) vibration of vibration member 220 caused by the sound wave generated by sound generation device 110; and setting the filter property of the correction filter based on a target sound-pressure transfer function between acoustic signal 201 and the target measurement signal.

According to aspect 8, it is possible to reduce an amount of sound waves generated by sound generation device 110 transmitting through vibration member 220.

An acoustic system manufacturing method according to aspect 9 includes aspect 8. The acoustic system manufacturing method according to aspect 9 includes: obtaining a first corresponding measurement signal by causing the measurement device to measure, at a position at which the target measurement signal has been measured, a sound wave generated as a result of first vibration unit 101 causing vibration member 220 to vibrate based on acoustic signal 201; setting a first filter property of first correction filter 131 based on a first corresponding sound-pressure transfer function between acoustic signal 201 and the first corresponding measurement signal; obtaining a second corresponding measurement signal by causing the measurement device to measure, at the position at which the target measurement signal has been measured, a sound wave generated as a result of second vibration unit 102 causing vibration member 220 to vibrate based on acoustic signal 201; and setting a second filter property of second correction filter 132 based on a second corresponding sound-pressure transfer function between acoustic signal 201 and the second corresponding measurement signal.

According to aspect 9, it is possible to manufacture acoustic system 100 that includes correction filter 130 having a filter property in which actual conditions are accurately reflected.

The acoustic system manufacturing method according to aspect 10 includes aspect 8 or aspect 9. In the acoustic system manufacturing method according to aspect 10, the target measurement signal is obtained in a state in which at least one of first vibration unit 101 in vibrator 120 or second vibration unit 102 in vibrator 120 is short-circuited.

According to aspect 10, it is possible to generate first filter property G1 and second filter property G2 with high accuracy.

The acoustic system manufacturing method according to aspect 11 includes any one of aspects 8 to 10. In the acoustic system manufacturing method according to aspect 11, a filter property of each of first correction filter 131 and second correction filter 132 is set based on a process sound-pressure transfer function between a processed signal and acoustic signal 201. The processed signal is obtained by performing statistical processing on target measurement signals measured at different positions. The target measurement signals each are the target measurement signal.

According to aspect 11, sound transmitting through vibration member 220 can be captured in a plane. Accordingly, it is possible to effectively reduce transmitted sound in a desired area.

The acoustic system manufacturing method according to aspect 12 is an acoustic system manufacturing method of manufacturing acoustic system 100 according to any one of aspects 3 to 7. The acoustic system manufacturing method according to aspect 12 includes: placing sound generation device 110 on one side of vibration member 220 to which vibrator 120 is attached; placing a measurement device on the other side of vibration member 220; obtaining a target measurement signal by causing the measurement device to measure at least one of (i) a sound wave generated by sound generation device 110 based on acoustic signal 201 or (ii) vibration of vibration member 220 caused by the sound wave generated by sound generation device 110; and setting a filter property of a correction filter based on a target sound-pressure transfer function between acoustic signal 201 and the target measurement signal.

According to aspect 12, it is possible to manufacture acoustic system 100 that can reduce an amount of sound waves generated by sound generation device 110 transmitting through vibration member 220.

An acoustic system manufacturing method according to aspect 13 includes aspect 12. The acoustic system manufacturing method according to aspect 13 includes: obtaining a first corresponding measurement signal by causing the measurement device to measure, at a position at which the target measurement signal has been measured, a sound wave generated as a result of first vibration unit 101 causing vibration member 220 to vibrate based on acoustic signal 201; setting a first filter property of first correction filter 131 based on a first corresponding sound-pressure transfer function between acoustic signal 201 and the first corresponding measurement signal; obtaining a second corresponding measurement signal by causing the measurement device to measure, at the position at which the target measurement signal has been measured, a sound wave generated as a result of second vibration unit 102 causing vibration member 220 to vibrate based on acoustic signal 201; and setting a second filter property of second correction filter 132 based on a second corresponding sound-pressure transfer function between acoustic signal 201 and the second corresponding measurement signal.

According to aspect 13, it is possible to manufacture acoustic system 100 that includes correction filter 130 having a filter property in which actual conditions are accurately reflected.

The acoustic system manufacturing method according to aspect 14 includes aspect 12 or aspect 13. In the acoustic system manufacturing method according to aspect 14, the target measurement signal is obtained in a state in which at least one of first vibration unit 101 in vibrator 120 or second vibration unit 102 in vibrator 120 is short-circuited.

According to aspect 14, it is possible to generate first filter property G1 and second filter property G2 with high accuracy.

The acoustic system manufacturing method according to aspect 15 includes any one of aspects 12 to 13. In the acoustic system manufacturing method according to aspect 15, a filter property of each of first correction filter 131 and second correction filter 132 is set based on a process sound-pressure transfer function between a processed signal and acoustic signal 201. The processed signal is obtained by performing statistical processing on target measurement signals measured at different positions. The target measurement signals each are the target measurement signal.

According to aspect 15, sound transmitting through vibration member 220 can be captured in a plane. Accordingly, it is possible to effectively reduce transmitted sound in a desired area.

While an embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2023-208606 filed on Dec. 11, 2023.

### INDUSTRIAL APPLICABILITY

The present disclosure is applicable to mobile objects, buildings, and the like having a space in which an amount of sound waves that is generated in a first space transmitting through vibration member 220 and leaking into a second space is desired to be reduced.

1. A vibrator comprising:
a first vibration unit that generates an excitation force to be applied to a vibration member to which the first vibration unit is attached;
a second vibration unit that generates an excitation force to be applied to the vibration member to which the second vibration unit is attached; and
a regulation member to which the first vibration unit and the second vibration unit are secured and which regulates relative movements between the first vibration unit and the second vibration unit.

2. The vibrator according to claim 1, further comprising:
a first correction filter that corrects an acoustic signal, and outputs the acoustic signal corrected to the first vibration unit; and
a second correction filter that corrects the acoustic signal, and outputs the acoustic signal corrected to the second vibration unit.

3. An acoustic system comprising:
the vibrator according to claim 2; and
a sound generation device that generates a sound wave based on the acoustic signal, wherein
the first correction filter and the second correction filter correct the acoustic signal to reduce transmitted sound that has changed from the sound wave by transmitting through the vibration member, and output the acoustic signals corrected to the first vibration unit and the second vibration unit.

4. The acoustic system according to claim 3, further comprising:
a delay filter that delays the acoustic signal, and outputs the acoustic signal delayed to the sound generation device.

5. The acoustic system according to claim 3, further comprising:
a common filter that corrects both (i) the acoustic signal to be output to the vibrator and (ii) the acoustic signal to be output to the sound generation device.

6. The acoustic system according to claim 3, wherein
each of the first correction filter and the second correction filter has a filter property derived based on a target sound-pressure transfer function between a target measurement signal and the acoustic signal, the target measurement signal being obtained by measuring, on a side of the vibration member at which the sound generation device is not placed, at least one of (i) a sound wave generated by the sound generation device based on the acoustic signal or (ii) vibration of the vibration member caused by the sound wave generated by the sound generation device.

7. The acoustic system according to claim 6, wherein
the first correction filter has a first filter property derived based on a first corresponding sound-pressure transfer function between a first corresponding measurement signal and the acoustic signal, the first corresponding measurement signal being obtained by measuring, at a position at which the target measurement signal has been measured, at least one of (i) a sound wave generated as a result of the vibrator causing the vibration member to vibrate based on the acoustic signal or (ii) the vibration, and
the second correction filter has a second filter property derived based on a second corresponding sound-pressure transfer function between a second corresponding measurement signal and the acoustic signal, the second corresponding measurement signal being obtained by measuring, at the position at which the target measurement signal has been measured, at least one of (i) a sound wave generated as a result of the vibrator causing the vibration member to vibrate based on the acoustic signal or (ii) the vibration.

8. An acoustic system control method of setting a filter property of a correction filter included in the acoustic system according to claim 3, the acoustic system control method comprising:
placing the sound generation device on one side of the vibration member to which the vibrator is attached;
placing a measurement device on an other side of the vibration member;
obtaining a target measurement signal by causing the measurement device to measure at least one of (i) a sound wave generated by the sound generation device based on the acoustic signal or (ii) vibration of the vibration member caused by the sound wave generated by the sound generation device; and
setting the filter property of the correction filter based on a target sound-pressure transfer function between the acoustic signal and the target measurement signal.

9. The acoustic system control method according to claim 8, further comprising:
obtaining a first corresponding measurement signal by causing the measurement device to measure, at a position at which the target measurement signal has been measured, a sound wave generated as a result of the first vibration unit causing the vibration member to vibrate based on the acoustic signal;
setting a first filter property of the first correction filter based on a first corresponding sound-pressure transfer function between the acoustic signal and the first corresponding measurement signal;
obtaining a second corresponding measurement signal by causing the measurement device to measure, at the position at which the target measurement signal has been measured, a sound wave generated as a result of the second vibration unit causing the vibration member to vibrate based on the acoustic signal; and
setting a second filter property of the second correction filter based on a second corresponding sound-pressure transfer function between the acoustic signal and the second corresponding measurement signal.

10. The acoustic system control method according to claim 8, wherein
the target measurement signal is obtained in a state in which at least one of the first vibration unit in the vibrator or the second vibration unit in the vibrator is short-circuited.

11. The acoustic system control method according to claim 8, wherein
a filter property of each of the first correction filter and the second correction filter is set based on a process sound-pressure transfer function between a processed signal and the acoustic signal, the processed signal being obtained by performing statistical processing on target measurement signals measured at different positions, the target measurement signals each being the target measurement signal.

12. An acoustic system manufacturing method of manufacturing the acoustic system according to claim 3, the acoustic system manufacturing method comprising:
placing the sound generation device on one side of the vibration member to which the vibrator is attached;
placing a measurement device on an other side of the vibration member;
obtaining a target measurement signal by causing the measurement device to measure at least one of (i) a sound wave generated by the sound generation device based on the acoustic signal or (ii) vibration of the vibration member caused by the sound wave generated by the sound generation device; and
setting a filter property of a correction filter based on a target sound-pressure transfer function between the acoustic signal and the target measurement signal.

13. The acoustic system manufacturing method according to claim 12, further comprising:
obtaining a first corresponding measurement signal by causing the measurement device to measure, at a position at which the target measurement signal has been measured, a sound wave generated as a result of the first vibration unit causing the vibration member to vibrate based on the acoustic signal;
setting a first filter property of the first correction filter based on a first corresponding sound-pressure transfer function between the acoustic signal and the first corresponding measurement signal;
obtaining a second corresponding measurement signal by causing the measurement device to measure, at the position at which the target measurement signal has been measured, a sound wave generated as a result of the second vibration unit causing the vibration member to vibrate based on the acoustic signal; and
setting a second filter property of the second correction filter based on a second corresponding sound-pressure transfer function between the acoustic signal and the second corresponding measurement signal.

14. The acoustic system manufacturing method according to claim 12, wherein
the target measurement signal is obtained in a state in which at least one of the first vibration unit in the vibrator or the second vibration unit in the vibrator is short-circuited.

15. The acoustic system manufacturing method according to claim 12, wherein
a filter property of each of the first correction filter and the second correction filter is set based on a process sound-pressure transfer function between a processed signal and the acoustic signal, the processed signal being obtained by performing statistical processing on target measurement signals measured at different positions, the target measurement signals each being the target measurement signal.
